(19) United States
(12) Patent Application Publication
(10) Pub. No.: US 2018/0118888 A1
(43) Pub. Date: May 3, 2018

(54) HIGH ELECTRO-THERMAL PERFORMANCE 3D SCAFFOLD EMBEDDED POLYIMIDE FOR VARIOUS APPLICATIONS

(71) Applicants: SOREQ NUCLEAR RESEARCH CENTER, Yavne (IL); NANYANG TECHNOLOGICAL UNIVERSITY, Singapore (SG)

(72) Inventors: Assaf BOLKER, Yavne (IL); Nurit ATAR, Yavne (IL); Ronen VERKER, Yavne (IL); Eitan GROSSMAN, Yavne (IL); Manuela LOEBLEIN, Singapore (SG); Siu Hon Hon TSANG, Singapore (SG); Hang Tong Edwin TEO, Singapore (SG)

(21) Appl. No.: 15/572,501

(22) PCT Filed: May 5, 2016
(86) PCT No.: PCT/IB2016/052570

§ 371 Date: Nov. 8, 2017

(51) Int. Cl. C08G 73/10; C08K 3/04

(52) U.S. Cl. CPC C08G 73/1071; C08K 2201/011; C08K 2201/001; C08K 3/042

(57) ABSTRACT

A polyimide produced from a polyamic acid solution of PMDA-ODA (pyromellitic dianhydryde-oxydianiline) in N-methyl-2-pyrrolidone (NMP).

### FIELD OF THE INVENTION

The present invention relates generally to polymers in the fields of organic and flexible electronics, and particularly to a scaffold embedded polyimide with high electrical and thermal conductivity.

### BACKGROUND OF THE INVENTION

Polymers such as polyimide have had a major impact in the fields of organic and flexible electronics. This special attention owes to their versatility and low cost. Their thermal stability, high modulus of elasticity, high tensile strength, ease of fabrication and ease of moldability make them highly suitable for application in electronics (substrates), packaging (encapsulation) and shielding (protective coatings). Nevertheless, several problems still hinder their use in a wider range of flexible electronic applications.

One of these major issues is the polymer's poor heat dissipation. High thermal dissipation and tolerance is a characteristic required for application in high density, high power electronic devices. This thermal management has always been an “up-hill” battle for electronic development due to the continued shrinking of devices, escalating density of transistors and the endless demand for power and performance. This issue is further compounded for flexible electronics [1], considering the low thermal conductivity of the typical polymer substrates. For comparison, the thermal conductivity of crystalline Si is in the range of 100 Wm⁻¹K⁻¹ [2] and polymers such as poly(methyl methacrylate) (PMMA) are in the range of 0.2 Wm⁻¹K⁻¹ [3]. This drastic difference in their thermal dissipation capability bears heavily on the designers of flexible devices. Inevitably, the performance of these devices will need to throttle down to reduce power consumption in order to decrease the heat generated by their operation. What is needed is a new way to drastically improve the thermal properties of the current polymers used in substrates.

One way to mitigate this issue is to infuse higher thermal conductivity materials into the polymer matrix to improve its overall conductivity. Recently, there is a growing interest to use highly thermally conductive nanomaterials as “nanofillers” for infusing into the matrix. For example, aligned MWNT (multi-walled nanotubes) composites were prepared by in-situ injection molding of silicone elastomer on to CVD (chemical vapor deposition) grown MWNT array resulting in a thermal conductivity of 0.65 Wm⁻¹K⁻¹ [4].

High density aligned MWNTs arrays were also exploited by Wardle et al. for epoxy infiltration [5-7]. Biaxial mechanical densification was used for CVD grown array (1 vol %) which was delaminated from its substrate. The density of the CNTs (carbon nanotubes) was controlled between 1-20 vol % with relatively low thermal conductivities of 0.29-3.6 Wm⁻¹K⁻¹, respectively [5]. Other common fillers include nanomaterials such as graphene [8] and metallic nanoparticles [9].

Although improvements of the overall conductivity can be obtained using this approach, there are still considerable challenges, such as inhomogeneous distribution of the nanofiller within the polymer matrix, aggregation and low filling fraction. Another critical concern is the poor long range thermal conduction seen in many of these composites as only a fraction of these individual nanomaterials are coupled together (weakly through Van der Waal forces) and most of the fillers are generally encapsulated entirely by the polymer matrix.[10]

In order to overcome this typical bundling, encapsulation and distribution problems, recently a new type of interconnected scaffold, three-dimensional graphene (3D-C), [11, 12, 13] has been proposed as a stable and robust filler for polymers.[12, 14] This 3D-C structure has been reported to render high electrical and thermal conductivity [13] without altering the other intrinsic properties of the polymer. Nevertheless, the so far reported structures all contain a residual bottom layer of polymer without any filler, which decreases the performance.

Another issue which often is neglected is the long-term stability of these new polymer-nanocomposites. Characterization of the films is usually carried out when the samples are “fresh” and usually no long-term study is carried out for the possible effects on the polymer caused by the filler, which may aggravate in time. Such aging studies are particularly important for high-stress and harsh environment applications such as flexible electronics and space-shield protective coatings, respectively.

### SUMMARY OF THE INVENTION

According to one aspect of the invention, an improved scaffold embedded, residue-free polymer with high electrical and thermal conductivity, is provided and described more in detail herein below.

According to another aspect of the present invention, fillers of three-dimensional foams are used in a method to obtain residue-free polymer by dividing the polymerization step into several single segments. In order to monitor the long-term stability of the polymer film, aging studies have been conducted by exposing the films to extreme environments (e.g., space) and extreme wear and tear application (e.g., various bending and thermal cycles). In another aspect of the invention, a composite polymer with strong thermal and electrical properties, which can serve as a new flexible substrate and as well as qualified shielding protection with proven long-term stability, is provided. Polyimide based materials (such as KAPTON®) are currently the standard choice for both, substrate for flexible electronics and space shielding as it renders high temperature and UV stability and toughness [15]. Hence the polymer matrix used to form the composite exemplified in one embodiment is a polyimide produced from a polyamic acid (PAA) solution of the PMDA-ODA (pyromellitic dianhydryde-oxydianiline) in N-methyl-2-pyrrolidone (NMP).

One or more aspects of the disclosure herein may, where appropriate to one skilled in the art, be combined with any one or more other aspects described here, and/or with any one or more features described herein.

### BRIEF DESCRIPTION OF THE DRAWINGS

Hereinafter, the present invention will be described more fully with reference to the accompanying figures/drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art.

The present invention will be understood and appreciated more fully from the following detailed description taken in conjunction with the non-limiting examples and drawings in which:

FIGS. 1A-1F: Characterization of 3D-C/KAPTON® film. (1A) Optical images of the bare 3D-C and the nanocomposite film; (1B) Raman spectroscopy before (blue, bottom) and after (red, top) infusion of 3D-C with insets of SEM images taken at the cross-section of the respective films; (1C) XPS survey results of bare KAPTON® (blue, top) and composite film (red, bottom); (1D-1F) high resolution XPS C 1s, N 1s and O 1s spectra, respectively for the two films.

FIGS. 2A-2D: Thermal and electrical conductivity results. (2A) Thermal conductivity results at a temperature range of 0° C.-200° C. for 3D-C/KAPTON® film, compared to bare KAPTON®, (2B) bare 3D-C vs. 3D-C/KAPTON® electrical conductivity at a temperature range of 20° C.-200° C., (2C) 3D-C/KAPTON® after one heating/cooling cycle from −160° C. to +200° C. (inset: fit of VRH nature, that is ln(RT^{-1/2})˜(1/T)^{1/4}); (2D) monitored electrical conductivity after repeated heating and cooling cycles.

FIG. 3: Sheet resistance monitored after 260 times bending of the film

FIGS. 4A-4C: Aging studies assessed through simulated space environment exposure. (4A) AO exposure results of nanocomposite film, KAPTON® film and bare 3D-C at high fluency (10²⁰) which represents an exposure time scale of 5-10 years in LEO orbit (life time of satellites in orbit); (4B) Gamma-ray exposure results for the nanocomposite film at different doses. (4C) Electrical conductivity at temperature range from 20° C.-200° C. and from 200° C.-to 20° C. of a previously Gamma ray exposed 3D-C/KAPTON® film.

### DETAILED DESCRIPTION OF EMBODIMENTS

As mentioned above, the polymer in one embodiment is a polyimide produced from a polyamic acid solution of the PMDA-ODA in N-methyl-2-pyrrolidone (NMP).

Preparation:

In one non-limiting example, samples were prepared via a two-step process, consisting namely of the fabrication of the graphene-foam (3D-C) skeleton and its infiltration with the pyromellitic dianhydryde-oxydianiline (PMDA-ODA) matrix.

The 3D graphene can be obtained through, but is not limited to, a direct synthesis method using template-directed thermal chemical vapor deposition (TCVD) [13]. Various other growth mechanisms comprising methods involving soft templates or template free approaches may be used to synthesize the 3D graphene. In this case, the growth of 3D-C is carried out in a split tube furnace using metal foam (e.g. nickel, cupper) as a catalytic substrate. After annealing of the substrate, the graphene precursor gas including but not limited to ethanol vapor, CH₄, C₂H₂ is led into the quartz tube under constant carrier gas and hydrogen flow. This allows the decomposing of the C-precursor and the synthesis of graphene film on the surface of the metal foam [16]. Afterwards, the as-grown 3D-C/Ni sample is dip-coated with a protective layer (e.g. PMMA). After hardening of the protective layer, the structure is subsequently immersed into hot diluted acid/metal etchant (e.g. HCl) to completely etch off the metal supporting structure. After removing the protective layer (may depend on material used, for example PMMA can be removed through annealing or acetone), the result is a freestanding, ultra-light weight and flexible graphene foam.

Other methods to obtain the three-dimensional graphene structure can be classified according to the template used and pore size yield; some examples are the use of biomolecules or aerogels, freezing of solutions containing C-precursors such as polymers, and electro deposition of graphene. A more comprehensive list can be found in (Han, Wu et al. 2014) [35].

In order to produce the nano-composite film, the 3D graphene structure is positioned on a silicon wafer with thermal oxide layer (SiO₂). For a typical hybrid film of 150-170 μm thickness, a solution of polymer matrix precursor comprising PAA (polyamic acid) diluted with NMP in a ratio of 1:3 is first poured on the surface of the porous 3D graphene structure. The PAA-3D graphene system is then heated to around 100° C. in order to remove the NMP after which another layer of diluted PAA is added. The PAA solution is then cured into PI (polyimide) by gradual heating to 350° C. in nitrogen atmosphere, based on a process developed by DuPont, Inc. [17,18]. Finally, an additional layer of undiluted PAA solution [19] is poured on the samples and the curing process is repeated again. The resulting free-standing flexible 3D graphene-PI films can then be obtained by peeling the nanocomposites from the Si substrate. The peeling off is enabled due to reduced adhesion between the PI and the Si substrate as a result of the oxide layer deposition on the Si wafer. The final amount of dilution and pouring/curing steps will depend on the final thickness attained.

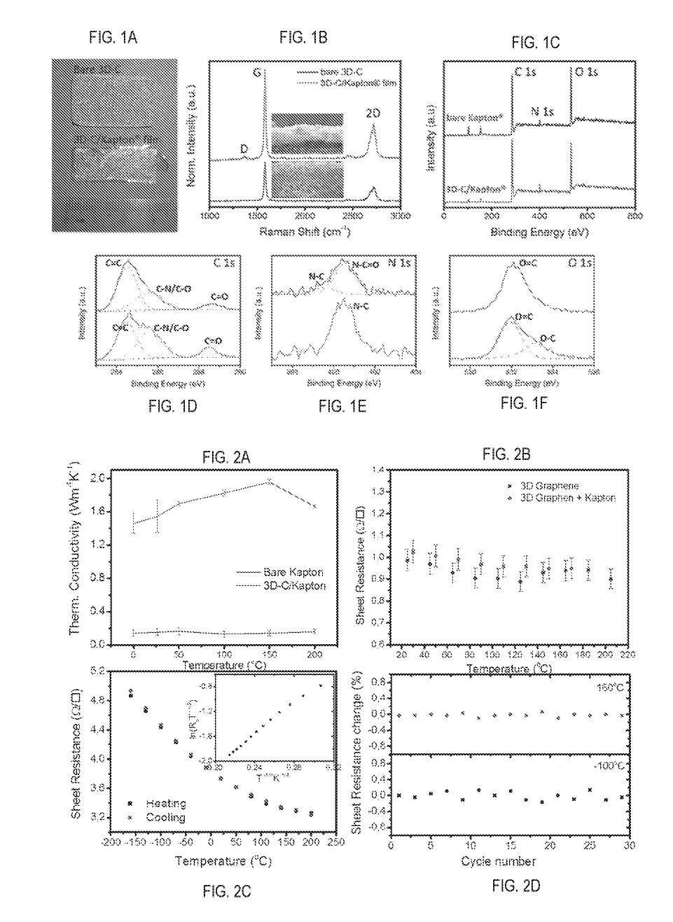

Optical images of both products are shown in FIG. 1a. Through consideration of its total volume and filling content, an exact amount of polymer is fabricated in order not to obtain supernatant polymer outside the volume pre-determined by the 3D-C.

### EXPERIMENTAL SECTION

Material Properties:

To verify the structural characteristics of the nanocomposite films, Raman spectroscopy and X-ray photoelectron spectroscopy were performed and the results are shown in FIG. 1b-f. These measurements confirmed that through the infusion of polyimide into 3D-C skeleton no parasitic interaction effects are induced into the graphene-based structure. This also holds true for the inverse case of the polyimide; its structure remains without alteration after the infiltration process. The Raman spectroscopy measurement indicates that the infiltration with the polyimide does not alter the crystalline structure of the 3D-C. Only a slight D-peak is detected in the infiltrated sample indicating the disorder in the polyimide 3D-C interface.

As described by Grossman et al. [20], the XPS (x-ray photoelectron spectroscopy) result matches the molecular structure of the polyimide, i.e. only the presence of C1s, N1s and O1s can be detected in the XPS survey spectra of the pristine polymer and the nanocomposite polymer, as shown in FIG. 1c. High-resolution XPS C 1s, N 1s and O 1s spectra of the two films are shown in FIG. 1d-f, respectively. Only slight variations in peak shapes and positions are observed between both. The C 1s peaks indicate that the predominant form of carbon is aromatic for both films. Small carbonyl peaks are also present in both films. The small shoulder of C—N/C—O bond of the bare film increases in the infiltrated film, which stands for the attachment between 3D-C and the polymer. The change in the N 1s spectrum from a combination of N—C and N—C═O bonds measured for the bare polyimide to only N—C bonds measured for the composite film is evidence of the good bonding between the 3D-C and the polyimide. This is further supported by the measured spread seen in the O 1s deconvolution from only O═C measured on the bare polyimide to the O═C and O—C bonds seen in the composite film measurement. In addition, this bonding between the polymer matrix and filler material is in agreement with the small D-peak detected by Raman previously. Besides this, after the infiltration with 3D-C no major changes in the pristine chemical structure of the polymer can be seen.

In order to improve current polymer materials, two aspects are of major interest: thermal and electrical conductivity. For the thermal aspect, measurements have been carried out using the laser flash technique over a temperature range of 0-200° C. and the results are displayed in FIG. 2a. For the electrical aspect, bare 3D-C′s and nanocomposite film's electrical conductivity were measured using a Hall effect/resistivity system using the 4-point Van der Pauw method at different temperatures and are displayed in FIG. 2b.

The thermal conductivity of the polyimide is increased by one order of magnitude when infiltrated with the 3D-C skeleton. In numbers: at room temperature the bare polymer has a thermal conductivity of 0.15 Wm⁻¹K⁻¹ which remains in this region also at elevated temperatures, whereas the 3D-C/polyimide film was measured to be more than 1 order of magnitude higher at 1.5 Wm⁻¹K⁻¹ in room temperature and slightly increasing with temperature rise (top value of 1.9 Wm⁻¹K⁻¹ at 150° C.). These values are similar to those reported to the bare 3D-C thermal conductivity [13, 21].

The electrical conductivity results remain the same for both, the pristine 3D-C and the nanocomposite film (within the error deviations). As it is the case for the chemical structures, also the C-skeleton's electrical conductivity is barely affected by the addition of the PI.

This stability in thermal and electrical conduction between the bare foam and the infiltrated foam is made possible due to interconnected nature of the filler itself. The foam-like structure is an interruption-free pathway for electron as well as phonon transport. This pathway remains well-preserved after the polymers infiltration, such that no alterations are caused which could alter the performance.

In order to understand the behavior and monitor its aging stability, electrical conductivity measurements were carried out under repeated heating and cooling cycles. FIG. 2c shows a single heating-cooling cycle from −160° C. to +200° C. of two samples. The first is that of a pristine 3D-C and the second is that of the composite film. The result has been fitted with several conduction behaviors and both samples have been found to best suit the Variable Range Hopping (VRH) behavior by C. Godet [22] and its fit is shown in the inset. The resistance R follows a three-dimensional VRH behavior due to carriers hopping between energy levels within band-tails.

$$R ( T ) = {R}_{00} {T}^{\frac{1}{2}} exp ( {( \frac{{T}_{0}}{T} )}^{\frac{1}{4}} ) \qquad ( 1 )$$

Where R₀₀ is the band tail's resistivity pre-factor and T₀ is the temperature coefficient that contains the hopping parameters, i.e. the density of states and the localization length of the wave-function. Similar electrical conduction behavior have been reported in the literature by both C. Godet et-al and Q. Li et-al for CNT bundles, CNT fibers and other carbon based materials [23,24]. The fact that both the pristine 3D-C sample and the composite film exhibit the same VRH conductivity behavior further indicates that the addition of the polymer layer did not damage the electronic conduction properties of the 3D-C. Furthermore, this result indicates that the conductivity in the 3D-C skeleton involves regions of metallic conduction together with hopping through small electrical barriers corresponding to the graphene sheets grain boundaries and defects of various types.

The first measurement related to aging study is shown in FIG. 2d, which shows the sheet resistance results of 30 repetitions of heating (up to +160° C.) and cooling (down to −100° C.) cycles. Temperatures beyond the usual storage (RT) and operating points (70° C.−130° C.) were chosen in order to accelerate the effects of cycling on materials' performance. It can be seen that the electrical conductivity is not affected by repeated thermal stresses.

The present invention may be applied but not limited to one or more of the following uses.

Flexible Electronics Application:

The flexible technology market is a good example for highlighting the issues related to aging of materials: flexible electronics technology provides a non-rigid and versatile platform that extends many conventional electronics into a large diversity of novel applications, such as in healthcare (i.e. bionic eye [25] and optic nerve [26]), flexible battery,[27] conformable RFID tags,[28] displays[29] and touch screens [30]. Polymers in this case are the platform for withstanding bending cycles and stretching. It must be guaranteed that the material will conserve its thermal, electrical and mechanical properties over a period of standard life-time of electronics while being subject to bending and stress.

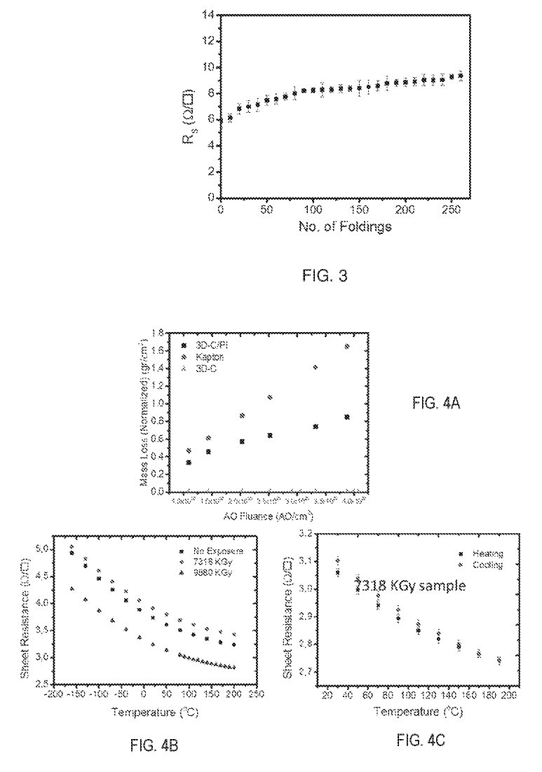

In order to account for this, electrical conductivity measurements have been carried out after repeated bending cycles. A bending angle far beyond the usual stress applied on flexible electronics was chosen in order to accelerate possible effects on performance (260 turns around a 3.4 mm ceramic cylinder). The results are displayed in FIG. 3 and show that the sheet resistance of the film remains stable throughout the repeated bending tests. The sheet resistance increased only from 5.9 Ω/□ to 9.37 Ω/□.

Space Shielding Application:

For one of the most demanding aging studies, the material was exposed to one of the harshest environments possible: space. In space, all possible effects that appear due to aging will aggravate, thus via conducting accelerated space environment simulations, our materials' aging performance can be very well assessed.

In space, objects are exposed to environments tremendously different from those encountered on Earth. Each of these environments has the potential to damage or destroy any kind of material, object or spacecraft. Among all of spacecraft failures, approximately 25% are related to interactions with the space environment [31].

The typical orbits in which most satellites are launched to are namely LEO (low earth orbit, at 160-2000 km altitude) and GEO (geosynchronous equatorial orbit, at 35786 km altitude) and are the standard regions targeted in tests. These are very hostile environments, components and materials exposed need to survive constant degradation from the environment. In LEO, these include atomic oxygen (AO), ultraviolet (UV) and ionizing radiation, ultrahigh vacuum (UHV), thermal cycles (±100° C. every 90 min.), and hypervelocity micrometeoroids and orbital debris [32]. Among these, the major concerns for satellites are the AO exposure and radiation effects. AO is known to have a highly reactive nature which causes unwanted chemical interactions and is one of the greatest concerns for long-term missions. AO can lead to oxidation, erosion and degradation of materials properties (such as mass loss). AO coatings must not only withstand high doses over a long term but also must be thin in order to maintain thermal properties of the materials they protect.

In order to carry out the aging studies, AO and Gamma ray exposures were performed at different doses, as well as outgassing tests according to European standards. FIG. 4 summarizes the results.

Exposure to Atomic Oxygen

AO exposure was carried out using the system previously described by Shpilman et al [34]. The samples were positioned in a region which consists of a mix of ground state AO and oxygen ions without UV. AO exposure was carried out on bare 3D-C and on the nanocomposite film at high fluencies (10²⁰ AO/cm²). Higher fluencies represent an exposure time scale of 5-10 years in LEO orbit (which is the life time of satellites in orbit).

The AO exposure mass loss results of the 3D-C/Polyimide film are shown in FIG. 4a together with the mass loss result of a reference KAPTON® film exposed to the same AO fluencies. The 3D-C/Polyimide film etch rate is about half of that of a pure KAPTON® film.

The RE (reaction efficiency) of the 3 materials, together with a comparative value of HOPG (highly ordered pyrolytic graphite) are shown in Table 1.

TABLE 1
Atomic oxygen (AO) exposure results for different materials

| Material | Etch Rate RE [cm³/AO] |
|---|---|
| Bare KAPTON ® | 3 × 10⁻²⁴ |
| Bare 3D-C | 1.2 × 10⁻²⁶ |
| HOPG | 8.6 ×× 10⁻²⁶ |
| KAPTON ®/3D-C | 1.679 × 10⁻²⁴ |

Ionizing Particle Radiation Exposure, Simulated by Gamma Ray Exposure

The nanocomposite film was exposed to about 10 mega Gy (0.1 giga rad). This is equivalent to 10 years in space (GEO orbit electron radiation dose). The exposure to gamma rays (cobalt 60 source spectral peaks at 1.33 Mev and 1.17 Mev) was at room temperature in atmospheric pressure. This measurement simulates ionizing radiation in

GEO space environment, which is dominated by electrons and lower flux of solar protons, with typical total irradiation doses of 0.7 MGy/yr.

In order to assess long-term performance, three electrical conductivity measurements of the 3D-C/KAPTON® were carried out, one for an unexposed sample piece, the second for the exposed sample piece at 7135 KGy and another after exposure to 9880 KGy, shown in FIG. 4b. It can be seen that no change in the film conductivity and no degradation in the film is visible. This makes this material suitable to withstand the high doses in GEO. FIG. 4c shows the 7135 KGy exposed film after one heating and one cooling cycle, and it can be seen that the film preserves completely its properties.

Outgassing

Outgassing is the release of gas that was either contained or absorbed by the material. It was assessed following the standard ECSS-Q-70-02A (from 26 May 2000).

The limit values are RML<1% (residual mass loss) and CVCM<0.1% (collected volatile condensable materials) and the results for the 3D-C/PI film are well below these limits with:

RML=0.296%

CVCM=0.058%

Conclusion

The present invention presents a new approach to infiltrate polymers with an intrinsically networked skeleton. Instead of the typical dis-conjoined fillers, the present invention is an intrinsically interconnected network of 3D-C, foam-like graphene. Using this kind of network, the required volume prior to infiltrating the polymer can be determined, avoiding any formation of bottom bare polymer residual layer, which is usually the case. This approach allows the properties of the foam to remain intact, while greatly enhancing the polymers electrical and thermal properties.

Aging studies were carried out by exposing the films to various thermal and bending cycles. Exposure to space environment has been used as an ultimate accelerated aging study. For this, atomic oxygen and gamma ray exposure and outgassing tests were performed. The results have shown that this class of film remains both thermally and electrically conductive after mechanical bending and exposure to ionizing radiation. Exposure to atomic oxygen revealed that the composite 3D-C/PI film is 3 times more resistant to etching than pure polyimide due to the low etch rate of the 3D-C skeleton. While these results show an improved film resistance to AO etching, it is still not within the acceptable levels to be used in the outer layers of LEO orbit space crafts. As such it can be used on the outer layers of GEO orbit space crafts, where no AO is present.

The high performance composite polyimide/3D graphene film shows good electrical and thermal conductivity, which are properties most suitable for flexible electronics applications and (space) protective shielding.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

### REFERENCES

[1] Y. Sun, J. A. Rogers, Advanced Materials 2007, 19, 1897.
[2] C. J. Glassbrenner, G. A. Slack, Physical Review 1964, 134, A1058.
[3] D. G. Cahill, R. O. Pohl, Physical Review B 1987, 35, 4067.
[4] Huang, H.; Liu, C.; Wu, Y.; Fan, S. Aligned carbon nanotube composite films for thermal management. 2005, 17, 1652-1656.
[5] Marconnet, A. M.; Yamamoto, N.; Panzer, M. A.; Wardle, B. L.; Goodson, K. E. Thermal Conduction in Aligned Carbon Nanotube-Polymer Nanocomposites with High Packing Density. 2011.
[6] Garcia, E. J.; Saito, D. S.; Megalini, L.; Hart, A. J.; Villoria, R. G.; Wardle, B. L. Fabrication and multifunctional properties of high volume fraction aligned carbon nanotube thermoset composites. 2009, 1, 1-11.
[7] Cebeci, H.; Villoria, R. G.; Hart, A. J.; Wardle, B. L. Multifunctional properties of high volume fraction aligned carbon nanotube polymer composites with controlled morphology. Compos. Sci. Technol. 2009, 69, 2649-2656.
[8] J. Du, H.-M. Cheng, Macromolecular Chemistry and Physics 2012, 213, 1060; T. Kuilla, S. Bhadra, D. Yao, N. H. Kim, S. Bose, J. H. Lee, Progress in Polymer Science 2010, 35, 1350.
[9] H. E.-D. a. M. Nazempour, Thermal Conductivity of Nanoparticles Filled Polymers, Intech; 1ST edition, Apr. 18, 2012.
[10] A. L. Moore, L. Shi, Materials Today 2014, 17, 163.
[11] A. Bello, K. Makgopa, M. Fabiane, D. Dodoo-Ahrin, K. I. Ozoemena, N. Manyala, Journal of Materials Science 2013, 48, 6707; X. Cao, Y. Shi, W. Shi, G. Lu, X. Huang, Q. Yan, Q. Zhang, H. Zhang, Small 2011, 7, 3163.
[12] Z. Chen, W. Ren, L. Gao, B. Liu, S. Pei, H.-M. Cheng, Nat Mater 2011, 10, 424.
[13] M. Loeblein, R. Y. Tay, S. H. Tsang, W. B. Ng, E. H. T. Teo, Small 2014, 10, 2992.
[14] J. Jia, X. Sun, X. Lin, X. Shen, Y.-W. Mai, J.-K. Kim, ACS Nano 2014.
[15] J. Megusar, Journal of nuclear materials 1997, 245, 185; D. H. P. Materials.
[16] S. J. Chae, F. Güneş, K. K. Kim, E. S. Kim, G. H. Han, S. M. Kim, H. J. Shin, S. M. Yoon, J. Y. Choi, M. H. Park, Advanced Materials 2009, 21, 2328.
[17] TB, PYRALIN® Polyimide Coating PI 2545 PI 2540, Product Information, Du-Pont. Inc, February 1993
[18] R. Verker, E. Grossman, N. Eliaz, Acta Materialia 2009, 57, 1112.
[19] Nurit Atar, E. G., Irina Gouzman, Asaf Bolker, Yael Hanein, ACS Applied Materials & Interfaces, 2014 6 (22), 20400-20407.
[20] E. Grossman, Y. Lifshitz, J. T. Wolan, C. K. Mount, G. B. Hoflund, Journal of Spacecraft and Rockets 1999, 36, 75.
[21] M. T. Pettes, H. Ji, R. S. Ruoff, L. Shi, Nano Letters 2012, 12, 2959.
[22] C. Godet, Philos. Mag. B 81 (2001) 205
[23] C. Godet, Diamond Relat. Mater. 12 (2003) 159
[24] Qingwen Li et-al, Adv. Mater. 2007, 19, 3358-3363
[25] T. Guenther, N. H. Lovell, G. J. Suaning, Expert Review of Medical Devices 2012, 9, 33.
[26] S. S. Lane, B. D. Kuppermann, I. H. Fine, M. B. Hamill, J. F. Gordon, R. S. Chuck, R. S. Hoffman, M. Packer, D. D. Koch, American Journal of Ophthalmology 2004, 137, 993.
[27] P. Liu, E. Sherman, A. Jacobsen, Journal of Power Sources 2009, 189, 646.
[28] J. Minhun, K. Jaeyoung, N. Jinsoo, L. Namsoo, L. Chaemin, L. Gwangyong, K. Junseok, K. Hwiwon, J. Kyunghwan, A. D. Leonard, J. M. Tour, C. Gyoujin, Electron Devices, IEEE Transactions on 2010, 57, 571.
[29] Z. Radivojevic, P. Beecher, C. Bower, S. Hague, P. Andrew, T. Hasan, F. Bonaccorso, A. C. Ferrari, B. Henson, in Proceedings of the 2012 Virtual Reality International Conference, ACM, Laval, France 2012, 1.
[30] S. Bae, H. Kim, Y. Lee, X. Xu, J.-S. Park, Y. Zheng, J. Balakrishnan, T. Lei, H. Ri Kim, Y. I. Song, Y.-J. Kim, K. S. Kim, B. Ozyilmaz, J.-H. Ahn, B. H. Hong, S. Iijima, Nat Nano 2010, 5, 574.
[31] A. C. Tribble, The space environment: implications for spacecraft design (revised and expanded edition), Princeton University Press, Princeton, 2003.
[32] M. R. Reddy, Journal of Materials Science 1995, 30, 281; L. Townsend, R. Fry, Advances in Space Research 2002, 30, 957; R. K. Tripathi, J. W. Wilson, R. C. Youngquist, Advances in Space Research 2008, 42, 1043; P. Spillantini, Advances in Space Research 2010, 45, 900.
[33] R. Vered, S. Matlis, G. Nahor, G. D. Lempert, E. Grossman, G. Marom, Y. Lifshitz, Surface and Interface Analysis 1994, 22, 532.
[34] Z. Shpilman, I. Gouzman, G. Lempert, E. Grossman, A. Hoffman, Review of Scientific Instruments 2008, 79.
[35] Han, S., et al. (2014). “Porous graphene materials for advanced electrochemical energy storage and conversion devices.” Advanced Materials 26(6): 849-864.

What is claimed is:

1. An article comprising:
a polyimide produced from a polyamic acid solution of PMDA-ODA (pyromellitic dianhydryde-oxydianiline) in N-methyl-2-pyrrolidone (NMP).

2. The article according to claim 1, further comprising an interconnected graphene-foam (3D-C) skeleton infiltrated with the PMDA-ODA.

3. The article according to claim 1, wherein said polyimide is part of a flexible electronics device.

4. The article according to claim 1, wherein said polyimide is part of a shield.

5. A method comprising:
producing a polyimide from a polyamic acid solution of PMDA-ODA (pyromellitic dianhydryde-oxydianiline) in N-methyl-2-pyrrolidone (NMP).

6. The method according to claim 5, further comprising forming a graphene-foam (3D-C) skeleton and infiltrating the 3D-C skeleton with the PMDA-ODA.

7. The method according to claim 6, wherein the 3D-C skeleton is formed by a direct synthesis method using template-directed thermal chemical vapor deposition (TCVD).

8. The method according to claim 7, wherein the 3D-C skeleton is coated with PMMA as a protective layer.

9. The method according to claim 6, further comprising the steps of:
a. positioning the 3D-C skeleton on a silicon substrate;
b. pouring a solution of PAA (polyamic acid) diluted with NMP on the surface of 3D-C skeleton;
c. heating to about 100° C. to remove the NMP;
d. adding another layer of diluted PAA;
e. curing the PAA into PI (polyimide) by gradual heating to about 350° C. in nitrogen atmosphere;
f. adding further layers of undiluted PAA onto the cured layers;
g. repeating the curing process to form a nanocomposite and
h. peeling the nanocomposite from the silicon substrate, wherein steps b-g are repeated according to the total thickness of the 3D-C required
